(19) United States
(12) Patent Application Publication
(10) Pub. No.: US 2004/0167981 A1
(43) Pub. Date: Aug. 26, 2004

(54) Method and system for monitoring relationships between content devices in a content delivery network

(76) Inventors: Christopher Paul Douglas, Loveland, CO (US); Chia-Chu Dorland, Fort Collins, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/372,314

(22) Filed: Feb. 25, 2003

(51) Int. Cl. G06F 15/173; G06F 17/30; G06F 7/00

(52) U.S. Cl. 709/225; 709/224; 707/10

(57) ABSTRACT

In accordance with an exemplary embodiment, a method for displaying relationships between content devices in a content delivery network, where the content devices include a management computer and a plurality of caches, includes querying one of the content devices, receiving a response from the queried content device indicating a content distribution path among the content devices, and based on the received response, displaying a map showing the indicated content distribution path(s) among the content devices.

### RELATED APPLICATIONS

Copending U.S. application No. ______, entitled “METHOD AND SYSTEM FOR MONITORING STREAMING MEDIA FLOW”, Attorney Docket No. 100110380-1 (032842-113), inventors Chris DOUGLAS, et al., filed in the U.S. Patent and Trademark Office on the same date as the present application, is hereby incorporated by reference. Copending U.S. application No. ______, entitled “METHOD AND APPARATUS FOR MONITORING A NETWORK”, Attorney Docket No. 100110378-1 (032842-099), inventors Chris DOUGLAS, et al., filed in the U.S. Patent and Trademark Office on the same date as the present application, is hereby incorporated by reference.

### BACKGROUND

Inktomi Corporation, Cisco Systems Inc., and CacheFlow (now Blue Coat Systems, Inc.) have manufactured various solutions for use in Content Delivery Networks (CDNs), including cache devices and Content Distribution Managers (CDMs), with accompanying software. Some of these solutions provide a management tool for homogeneous caches. U.S. Pat. No. 6,442,651 and U.S. Pat. No. 6,263,371 assigned to CacheFlow, U.S. Pat. No. 6,128,623 assigned to Inktomi Corporation, U.S. Pat. No. 6,449,647 assigned to Cisco Systems Inc., and U.S. Pat. No. 6,421,726 assigned to Akamai Technologies Inc. describe various aspects of networks and are hereby incorporated by reference.

These solutions can fail to manage heterogeneous caches, for example in a Content Delivery Network, and don't map relationships between caches and other caches, between caches and content managers, between caches and content routers, and between caches and content switches.

### SUMMARY

In accordance with exemplary embodiments, a method for displaying relationships between content devices in a content delivery network (CDN), where the content devices include for example a management computer and a plurality of caches, includes querying one of the content devices, receiving a query response from the content device indicating a content distribution path among the devices, and based on the received query response, displaying a map showing the indicated content distribution path(s) among the devices.

An exemplary a method for displaying relationships among devices in a computer network, where the devices include a plurality of caches, includes querying one of the caches, receiving a query response from the queried cache indicating other caches in the network that the first cache will contact to request content in the event the first cache receives a request for content not in the first cache. A map is displayed showing information received via the query response, for example which other caches in the network that the first cache will contact to request content in the event the first cache receives a request for content not in the first cache.

An exemplary machine readable medium can include software for causing a computing device to perform the exemplary method(s).

An exemplary system for monitoring relationships between content devices in a content delivery network, the content devices including a management computer and a plurality of caches, includes an agent configured to query one of the content devices and receive a response from the queried content device indicating a content distribution path among the content devices, and a display arranged to display a map showing the indicated content distribution path among the content devices.

An exemplary system for monitoring relationships between content devices in a content delivery network, the content devices including a management computer and a plurality of caches, includes means for querying one of the content devices, means for receiving a response from the queried content device indicating a content distribution path among the content devices, and means for displaying a map showing the indicated content distribution path(s) among the content devices, based on the received response.

### BRIEF DESCRIPTION OF THE DRAWINGS

Other objects and advantages of the exemplary embodiments will become apparent to those skilled in the art from the following detailed description of preferred embodiments, when read in conjunction with the accompanying drawings wherein like elements have been designated with like reference numerals and wherein:

FIG. 1 shows a display in accordance with exemplary embodiments, depicting distribution of data in an electronic network, for example a content delivery network.

FIG. 2 shows a data distribution process within a network in accordance with exemplary embodiments.

FIG. 3 shows a display in accordance with exemplary embodiments, depicting content resolution or distribution of data among caches in a network, for example a content delivery network.

FIG. 4 shows a process for collecting information about an electronic network in accordance with exemplary embodiments.

### DETAILED DESCRIPTION OF THE EXEMPLARY EMBODIMENTS

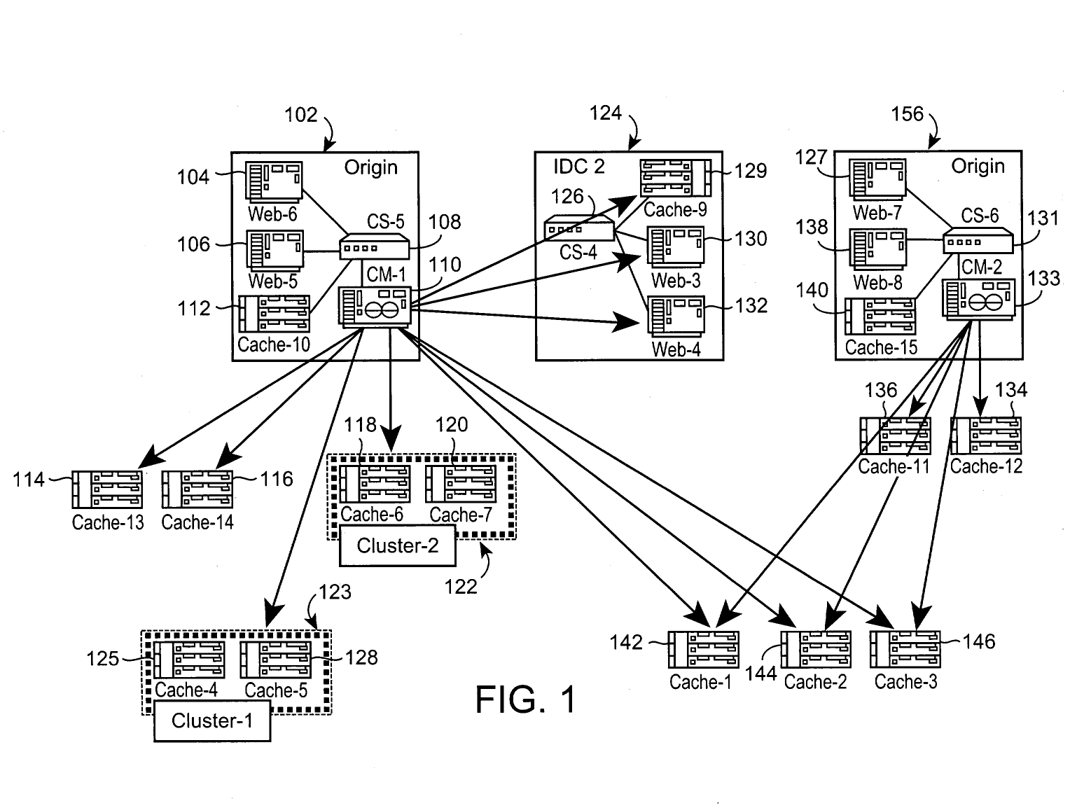

FIG. 1 illustrates a display of content distribution paths among content devices in a content delivery network (CDN), in accordance with an exemplary embodiment.

In FIG. 1, a content device within a CDN, such as the content manager 110, is queried and provides a response indicating one or more content distribution paths. For example, the response can indicate the caches to which the content device provides content. Based on the response, a map such as that shown in FIG. 1 is displayed showing the content distribution path(s), for example the links between the content manager 110 and the caches 114, 116, the cache clusters 122, 123, and the caches 142, 144, 146. Other content managers in the CDN can also be queried, for example the content manager 133, and content distribution path information in the corresponding response(s) can also be displayed on the map in similar fashion, as shown for example in FIG. 1.

As referenced herein, a CDN can be a system of distributed content on a large intranet or the public Internet in which copies of content are replicated and cached throughout the network. When content is replicated via the system throughout the country, or throughout the world, users have quicker access to it than if it resides on one Web site. CDNs can be provided, for example, by content delivery organizations such as Akamai, by large Internet Service Providers (ISPs) or by large enterprises. Specifically, a CDN can be implemented as an overlay to a traditional internet protocol (IP) network, and functions or operates based on layers 4-7 of the IP protocol stack. Layers 1-7 are defined in accordance with the International Organization for Standardization (ISO) model. A discussion of computer network protocols and layers of the ISO model is discussed, for example, in “Interconnections, Second Edition,” by Radia Perlman (Addison-Wesley, 2000), the disclosure of which is incorporated herein by reference in its entirety.

As referenced herein, a “content device” is a networking device that plays a role in a CDN, by a) storing or manipulating content, or b) processing requests for content, in the CDN. As referenced in this document, “content distribution path” represents a logical path between a source and a destination, as defined by a logical relationship existing at layers 4-7 of the overlay network of the CDN. Caches store content, and process or respond to requests for content. In the context of a CDN, a content device called a “router” processes requests for content but does not deliver or receive the content. Generally, devices that handle IP packets in a traditional fashion are not “content devices”. Thus, layer 1-3 devices, for example those beneath the CDN overlay network, are not “content devices”.

As shown in FIG. 1, caches in an electronic data network such as a computer network, or for example a content delivery network, can be efficiently monitored and modeled or displayed via a graphic presentation such as a map showing relationships that caches in the network have among themselves and with other devices within the network.

For example, the FIG. 1 display can be considered a map that shows relationships between heterogeneous content caches, content distribution managers, related content routers and content switches within a computer network, for example a content delivery network. This relationship mapping allows a user or administrator to visualize which caches receive updated content or information. Additional information can also be shown for each cache in the network, for example statistical data regarding the information or content stored in the cache, the status of the cache, and customer information.

The map shown in FIG. 1 illustrates cache deployment in a CDN, or in other words, distribution of electronic content or data to caches in the CDN. As shown in FIG. 1, the CDN includes a management computer such as the content manager 110 (CM-1). The CDN can include a plurality of management computers, as demonstrated for example by the content manager 133 (CM-2). As shown in FIG. 1, electronic data is distributed from an origin 102, and specifically from the content manager 110. Content switches in the CDN, such as the content switch 108, process requests for content but do not receive or transmit the content. A content switch can act as a load-balancer. For example, the content switch 108 (CS-5) in FIG. 1 can receive a content request from a user and can relay the request to the cache 112 (Cache-10), the webserver 106, or the webserver 104 for fulfillment.

The content manager 110 provides data directly to caches 114, 116, 142, 144, and 146. The content manager 110 also provides data to clusters 123, 122 or caches. The cluster 123 contains caches 125, 128 and the cluster 122 contains caches 118, 120. The Internet data center (IDC) 124 references a physical site with physical equipment, and includes a cache 129, web servers 130, 132 and a content switch 126.

There can be multiple origins of data within the network. For example, FIG. 1 also shows a second origin 156, including a second content manager 133 that also distributes data to caches in the network, and a content switch 131 (CS-6). The second origin 156 also includes web servers 127, 138 and a cache 140. The content manager 133 provides the data directly to the caches 134, 136, 142, 144, and 146. Note that a cache can receive data from different origins or content managers. For example, the caches 142, 144, 146 receive data from both of the content managers 110, 133.

In accordance with exemplary embodiments, a user or administrator can view detailed information regarding an element or device shown in the map by selecting the element. For example, the user can “right-click” on the icon of the cache 114 to obtain more information about that cache. Information about a cache can include a summary of data contained within the cache, a date and time on which the cache last received data, and so forth. Detailed information for either of the content managers 110, 133 can include a listing of devices in the network that the content manager provides data to, dates and times of recent data “pushes” from the content manager to recipient devices, protocols used by the content manager to communicate with the recipient devices and/or to send the data, status of an in-progress data “push”, and so forth.

Information for display on the map can be obtained by querying the content managers and/or the caches. The queries can be performed, for example, by a hardware and/or software agent that communicates with the content managers and/or caches, using queries and formats or protocols that the content managers and caches understand. The same agent, or a different agent, can organize the information gleaned from the queries and use the information to display a map on a monitor or screen to a user or administrator, as for example in FIG. 1. An example query to a content manager to obtain content distribution information, can take the following form:

“http://cdnManagerhttpserver:portNum/cdnManager?command=getCDNData”.

Those skilled in the art will recognize that since the content managers and caches can be off-the-shelf devices or systems such as those manufactured by Cisco and others, the queries, formats and protocols used to obtain information from them can depend on the configuration and design of the devices or systems, and can be provided by the manufacturer. Information provided by the content managers and/or caches can include a) identification of devices that the content managers and/or caches communicate with and provide data to or receive data from, b) identification of protocols and/or standards used by the content managers and/or caches, c) configuration data regarding the content managers and/or caches, and so forth.

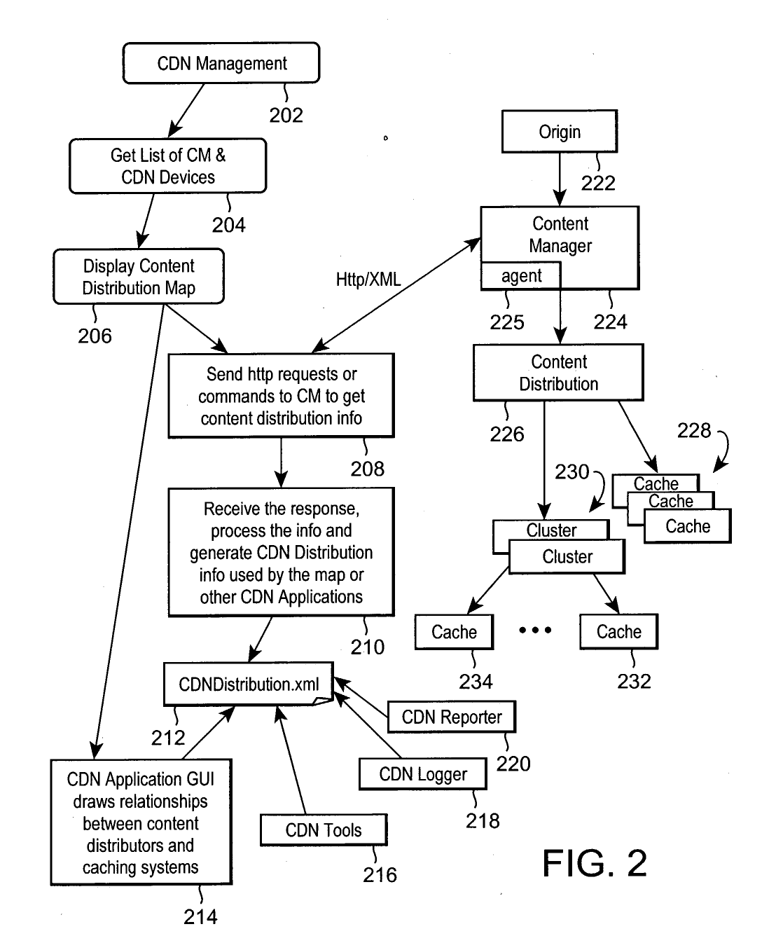

FIG. 2 shows an exemplary process consistent with FIG. 1, wherein a content delivery network manager or agent 202 obtains a list 204 of content managers and associated devices in the network, and creates a map 206 for display that shows relationships between the content managers and other devices in the network. In a process step 208, the agent 202 sends http (Hyper Text Transfer Protocol) or XML (eXtensible Markup Language) requests or commands to a content manager 224 in the network, to obtain content distribution information. The content manager 224 can respond to such requests or commands, or can include an agent 225 for responding to the requests or commands. The content manager 224 receives content or information from an origin 222, and in a content distribution step 226 the content manager 224 distributes the content to caches 228 and clusters 230 of caches 234, 232.

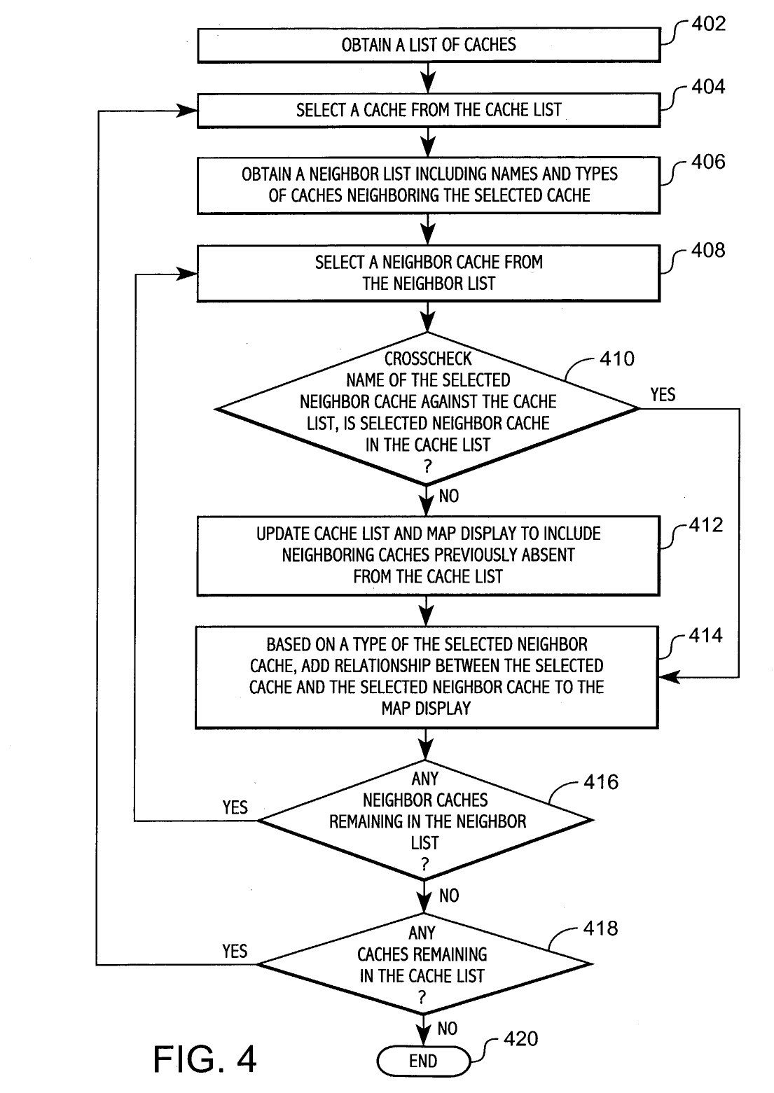

After receiving responses from the content manager 224, the agent 202 processes the information received via the responses in a step 210 for display in a map, as for example the map shown in FIG. 1. The agent 202 can generate an output file 212 based on the information received via the responses, for example in an XML format that can be used by the agent 202 or another agent 214 to generate the map. The output file can also be provided to other agents or functions such as tools 216, logger 218, and reporter 220 can use the output file 212. The agent 214 can be a content data network application including a graphical user interface, that forms the map by drawing the relationships between content distributors (such as the content managers) and caches or cache clusters in the system. The agents 202, 214 can be implemented in software on hardware resources of the network or on dedicated and/or independent hardware resources, can be implemented in hardware, or in any other appropriate fashion, and can be separate or combined. The agents 202, 214 can, for example, perform the functions shown in FIG. 4 and described herein.

An exemplary XML output file that can be generated in step 210, for example an exemplary response that a Content Manager would provide in reply to a query for content distribution information, which can be rendered to show the map or display of FIG. 1, can be as shown in the following paragraph. Note that the portion “<Cache Distribution> . . . </Cache Distribution>” includes specific data that can be used to render the map or display of FIG. 1.

```
<?xml version=“1.0”?>
<!-- edited with XML Spy v3.0.7 NT (http://www.xmlspy.com) by Chris
Douglas (OpenView) -->
<!-- @version: -->
<CMDistribution version=“1.0”>
    <CDNDevices>
        <Device id=“1” label=“Cache-1” type=“cache”
description=“Cisco Content Engine 590” status=“Normal”>
        ce101.cnd.hp.com
        </Device>
        <Device id=“2” label=“Cache-2” type=“cache”
description=“Cisco Content Engine 7320” status=“Normal”>
        ce102.cnd.hp.com
        </Device>
        <Device id=“3” label=“Cache-3” type=“cache”
description=“Cisco Content Engine 560” status=“Normal”>
        ce103.cnd.hp.com
        </Device>
        <Device id=“4” label=“Cache-4” type=“cache”
description=“Cisco Content Engine 507” status=“Normal”>
        ce104.cnd.hp.com
        </Device>
        <Device id=“5” label=“CR-1” type=“router” description=“Cisco
Content Router CR4400” status=“Normal”>
        cr101.cnd.hp.com
        </Device>
        <Device id=“6” label=“CR-4” type=“router” description=“Cisco
Content Router CR4400” status=“Normal”>
        cr102.cnd.hp.com
        </Device>
        <Device id=“7” label=“CS-1” type=“switch” description=“Cisco
Content Services Switches 11800” status=“Normal”>
        css101.cnd.hp.com
        </Device>
        <Device id=“8” label=“CS-2” type=“switch” description=“Cisco
Content Services Switches 11150” status=“Normal”>
        css102cnd.hp.com
        </Device>
        <Device id=“9” label=“CM-1” type=“distribution manager”
description=“Cisco Content Distribution Manager CDM4630”
status=“Normal”>
        cdm101.cnd.hp.com
        </Device>
        <Device id=“10” label=“CM-2” type=“distribution manager”
description=“Cisco Content Distribution Manager CDM4670”
status=“Normal”>
        cdm102.cnd.hp.com
        </Device>
        <Device id=“11” label=“Cache-5” type=“cache”
description=“Cisco Content Engine 7320” status=“Normal”>
        ce105.cnd.hp.com
        </Device>
        <Device id=“12” label=“Cache-6” type=“cache”
description=“Cisco Content Engine 560” status=“Normal”>
        ce106.cnd.hp.com
        </Device>
        <Device id=“13” label=“Cache-7” type=“cache”
description=“Cisco Content Engine 560” status=“Normal”>
        ce107.cnd.hp.com
        </Device>
        <Device id=“14” label=“Cache-8” type=“cache”
description=“Cisco Content Engine 560” status=“Normal”>
        ce108.cnd.hp.com
        </Device>
        <Device id=“15” label=“Cache-9” type=“cache”
description=“Cisco Content Engine 560” status=“Normal”>
        ce109.cnd.hp.com
        </Device>
        <Device id=“16” label=“Cache-10” type=“cache”
description=“Cisco Content Engine 560” status=“Normal”>
        ce110.cnd.hp.com
        </Device>
        <Device id=“17” label=“Cache-11” type=“cache”
description=“Cisco Content Engine 560” status=“Normal”>
        ce111.cnd.hp.com
        </Device>
        <Device id=“18” label=“Cache-12” type=“cache”
description=“Cisco Content Engine 560” status=“Normal”>
        ce112.cnd.hp.com
        </Device>
        <Device id=“19” label=“CS-3” type=“switch” description=
        “Cisco
Content Services Switches 11150” status=“Normal”>
        css103cnd.hp.com
        </Device>
        <Device id=“20” label=“CS-4” type=“switch” description=
        “Cisco
Content Services Switches 11150” status=“Normal”>
        css104cnd.hp.com
        </Device>
        <Device id=“21” label=“CS-5” type=“switch” description=
        “Cisco
Content Services Switches 11150” status=“Normal”>
        css105cnd.hp.com
        </Device>
        <Device id=“22” label=“CS-6” type=“switch” description=
        “Cisco
Content Services Switches 11150” status=“Normal”>
        css106cnd.hp.com
        </Device>
        <Device id=“23” label=“CS-7” type=“switch” description=
        “Cisco
Content Services Switches 11150” status=“Normal”>
        css107cnd.hp.com
        </Device>
        <Device id=“24” label=“CS-8” type=“switch” description=
        “Cisco
Content Services Switches 11150” status=“Normal”>
        css108cnd.hp.com
        </Device>
        <Device id=“25” label=“CS-9” type=“switch” description=
        “Cisco
Content Services Switches 11150” status=“Normal”>
        css109cnd.hp.com
        </Device>
        <Device id=“26” label=“CS-10” type=“switch”
description=“Cisco Content Services Switches 11150” status=“Normal”>
        css110cnd.hp.com
        </Device>
        <Device id=“27” label=“Cache-13” type=“cache”
description=“Cisco Content Engine 560” status=“Normal”>
        ce112.cnd.hp.com
        </Device>
        <Device id=“28” label=“Cache-14” type=“cache”
description=“Cisco Content Engine 560” status=“Normal”>
        ce112.cnd.hp.com
        </Device>
        <Device id=“29” label=“Cache-15” type=“cache”
description=“Cisco Content Engine 560” status=“Normal”>
        ce112.cnd.hp.com
        </Device>
    </CDNDevices>
    <CacheManagers>
        <CacheManager id=“CM1” label =“CM-1” name=“Cache
Manager Chia” device_id=“9”>
            <Host dnsname=“ovchia.cdn.hp.com”/>
            <Distributions>
                <Distribution id=“1”/>
                <Distribution id=“2”/>
                <Distribution id=“3”/>
            </Distributions>
        </CacheManager>
        <CacheManager id=“CM2” label=“CM-2” name=“Cache
Manager Chu” device_id=“10”>
            <Host dnsname=“ovccd.cdn.hp.com”/>
            <Distributions>
                <Distribution id=“4”/>
            </Distributions>
        </CacheManager>
    </CacheManagers>
    <Caches>
        <Cache id=“1” label=“Cache-1” device_id=“1”/>
        <Cache id=“2” label=“Cache-2” device_id=“2”/>
        <Cache id=“3” label=“Cache-3” device_id=“3”/>
        <Cache id=“4” label=“Cache-4” device_id=“4”/>
        <Cache id=“5” label=“Cache-5” device_id=“11”/>
        <Cache id=“6” label=“Cache-6” device_id=“12”/>
        <Cache id=“7” label=“Cache-7” device_id=“13”/>
        <Cache id=“8” label=“Cache-8” device_id=“14”/>
        <Cache id=“9” label=“Cache-9” device_id=“15”/>
        <Cache id=“10” label=“Cache-10” device_id=“16”/>
        <Cache id=“11” label=“Cache-11” device_id=“17”/>
        <Cache id=“12” label=“Cache-12” device_id=“18”/>
        <Cache id=“13” label=“Cache-13” device_id=“27”/>
        <Cache id=“14” label=“Cache-14” device_id=“28”/>
        <Cache id=“15” label=“Cache-15” device_id=“29”/>
    </Caches>
    <Clusters>
        <Cluster id=“1” label=“Cluster-1”>
            <Cache id=“4”/>
            <Cache id=“5”/>
        </Cluster>
        <Cluster id=“2” label=“Cluster-2”>
            <Cache id=“6”/>
            <Cache id=“7”/>
        </Cluster>
    </Clusters>
    <CacheDistribution>
        <Distribution id=“1” cluster=“1” cache=“0” descripton=“Cache
cluster”>
            <HostedDomains>
                <HostedDomain order=“1”> www.hp.com
</HostedDomain>
                <HostedDomain order=“2”> www.fc.com
</HostedDomain>
            </HostedDomains>
        </Distribution>
        <Distribution id=“2” cluster=“0” cache=“1-3,9,13-14”
descripton=“Content cache”>
            <HostedDomains>
                <HostedDomain order=“1”> www.hp.com
</HostedDomain>
                <HostedDomain order=“2”> www.ovbu.com
</HostedDomain>
            </HostedDomains>
        </Distribution>
        <Distribution id=“3” cluster=“2” cache=“0” application=“0”
descripton=“Cache cluster”>
            <HostedDomains>
                <HostedDomain order=“1”> www.hp.com
</HostedDomain>
                <HostedDomain order=“2”> sgbu.esgonline.com
</HostedDomain>
            </HostedDomains>
        </Distribution>
        <Distribution id=“4” cluster=“0” cache=“1-3,11-12”
descripton=“Content cache”>
            <HostedDomains>
                <HostedDomain order=“1”> www.sun.com
</HostedDomain>
                <HostedDomain order=“2”> www.java.com
</HostedDomain>
            </HostedDomains>
        </Distribution>
    </CacheDistribution>
    <Sites background_image=“”>
        <Site id=“1” label=“Fort Collins” type=“origin” status=
        “Normal”>
            <Device id=“1”/>
            <Device id=“2”/>
            <Device id=“5”/>
            <Device id=“8”/>
        </Site>
        <Site id=“2” label=“Roseville” type=“IDC” status=“Normal”>
            <Device id=“3”/>
            <Device id=“4”/>
            <Device id=“6”/>
            <Device id=“9”/>
        </Site>
        <Site id=“3” label=“LA” type=“POP” status=“Normal”>
            <Device id=“10”/>
            <Device id=“11”/>
            <Device id=“12”/>
        </Site>
    </Sites>
</CMDistribution>
```

In accordance with exemplary embodiments, content resolution among caches can be mapped to allow a user or administrator to visualize how caches share content with each other.

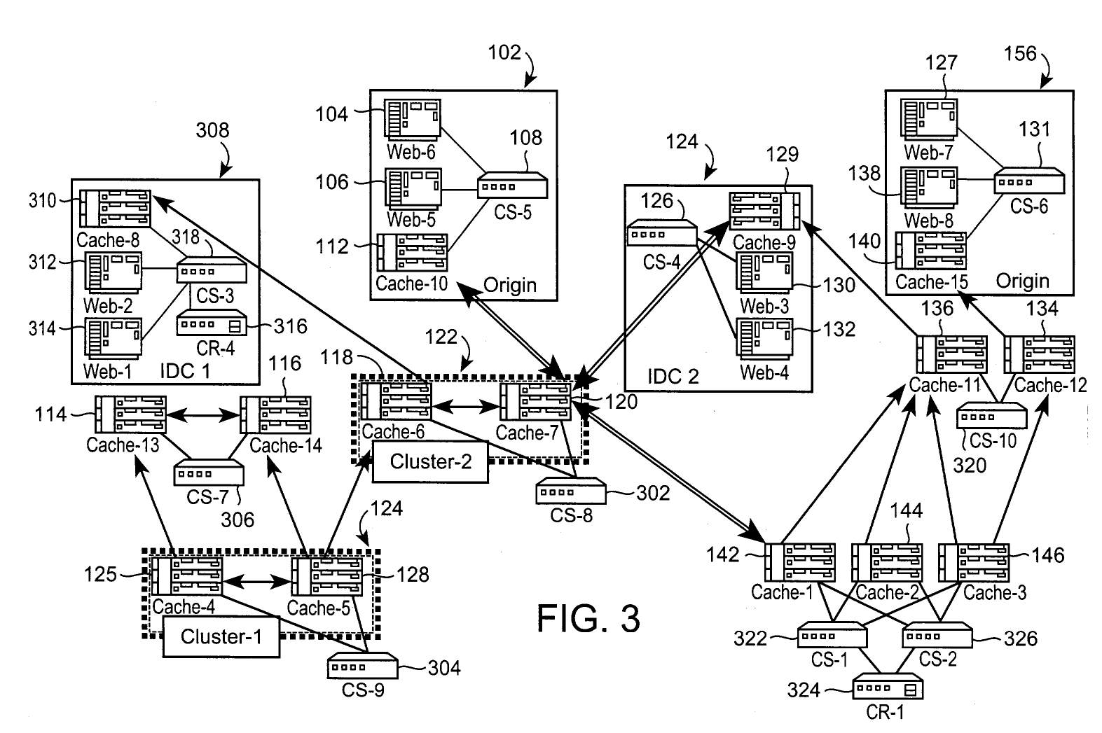

FIG. 3 shows a map generated in accordance with exemplary embodiments. The map illustrates content resolution among the caches in the network, or in other words, a hierarchy of links by which caches in the network share and distribute electronic content or data among themselves in the network. In an exemplary embodiment, the hierarchy is a logical hierarchy. In accordance with exemplary embodiments, three different kinds of links are available: 1) parent-child, 2) sibling-sibling, and 3) multicast.

In the parent-child type link, when a child cache receives a request for content that it does not have, the child cache contacts a cache that has a parent relationship to the child cache and requests the content from the parent cache. This relationship is represented in FIG. 3 as a solid line segment with a single arrowhead at one end, with the arrow pointing from a child to a parent. See, for example, the link connecting the cache 114 (Cache 13) and the cache 125 (Cache 4), which indicates that the cache 114 is a parent to the cache 125, and the cache 125 is a child to the cache 114. In an exemplary embodiment, a child cache can have multiple parent caches, as shown for example in FIG. 3 where the child cache 128 has two parent caches 116, 118.

In the sibling-sibling type link, either cache can request content from the other cache. This link is represented in FIG. 3 as a solid line segment with two arrowheads, one at each end of the line segment. For example, FIG. 3 shows that the caches 114, 116 are sibling caches so that the cache 114 can request content from the cache 116, and vice versa.

The multicast link is represented in FIG. 3 as a line segment formed by two parallel solid lines spaced apart and bounded with an arrowhead at each end. For example, the cache 120 has multicast links to each of the caches 112, 129, and 142. A cache can “multicast” by simultaneously requesting content from all caches that are connected to it with a multicast link. In an exemplary embodiment, each direct multicast link is a two-way link (as indicated by an arrowhead on each end of line segment), so that either cache on each end of the link can send a content request to the other cache. For example, the cache 120 can simultaneously request content from the caches 112, 129, and 142. However, the cache 142 has only one multicast link, to the cache 120, and thus when it multicasts a content request, the request would go only to the cache 120. In accordance with an exemplary embodiment, a multicast link can be unidirectional instead of bidirectional.

If a first cache receives a request from a second cache or any other computing device for content that the first cache does not have, the first cache can request the content from other caches, and convey the content back to the second cache after obtaining the content. For example, the cache 142 (or any other computing device) can request content from the cache 120. If the cache 120 does not have the content, then it can multicast a request for the content to the caches 112, 129 (and 142). After receiving the content, the cache 120 can then transfer the content to cache 142 or other computing device that requested the information.

In the event that a first cache requests content from another cache or from other caches and does not receive the requested content, the first cache can contact an origin or content manager directly to request the content. In the event the first cache is unable to obtain the content and the first cache is attempting to obtain the content at the request of another entity (for example, a user or another cache), the first cache can generate a message indicating the content has not been obtained, and send the message to the entity (for example, a user or another cache) that requested the content from the first cache.

As can be seen in FIG. 3, redundant links or information paths can be provided. For example, the cache 142 can receive information directly from the cache 120, or indirectly via the cache 129 and the cache 136.

FIG. 4 shows an exemplary method for discerning and displaying content resolution among the caches in the CDN, where for example the method includes querying a first cache in the CDN, receiving a response from the first cache indicating other caches in the network that the first cache will contact to request content in the event the first cache receives a request for content not in the first cache, and based on the received response, displaying a map showing which other caches in the network that the first cache will contact to request content in the event the first cache receives a request for content not in the first cache.

Specifically, in a first step 402 of FIG. 4, a cache list of caches in the network is obtained. This can be done, for example, by pulling an XML-format distribution file from a content manager in the network, as for example in step 208 of FIG. 2. From this file, all devices of type “cache” can be selected from a set of “CDNDevices” to build the cache list. In a next step 404, a cache is selected from the cache list.

In a next step 406, a neighbor list including names and types of caches neighboring the selected cache is obtained. This can be done, for example, by querying the selected cache using any appropriate request format and/or protocol, and the selected cache can reply to the query with information in any appropriate format. Also, the information in the query response can be organized before transmission, and/or can be (further) organized upon receipt. For example, the query can be an SNMP (Simple Network Management Protocol) query to obtain an ICP (Internet Caching Protocol) table containing a listing of caches that neighbor the selected cache, or in other words that communicate directly with the selected cache. The information in the table can be further organized upon receipt, for example by an agent that received the query response, for example by re-ordering and/or extracting information elements from the table for display in the map.

The listing in the ICP table of caches that neighbor the selected cache indicates communication pathways between the selected cache and the neighbor caches. Each neighbor cache entry in the table can include information about the neighbor cache and its relationship to the selected cache. For example, a neighbor cache entry can have the following form:

Neighbor cache hostname:

enterprises.nlanr.squid.cacheMesh.cachePeerTable.cachePeerEntry.cachePeerName.141.142.121.5: [hostname]

Neighbor cache type (Sibling==1, Parent==2, Multicast==3):

enterprises.nlanr.squid.cacheMesh.cachePeerTable.cachePeerEntry.cachePeerType.141.142.121.5: [cache type]

An exemplary SNMP query to obtain an ICP table can take the form:

snmpwalk cache1.hp.com squid.cacheMesh.cachePeerTable

This command can be initiated from a command line of a computer system, or as a call to a routine within a program.

The ICP table can be returned in an SNMP packet, in name:value pairs. For example:

squid.cacheMesh.cachePeerTable.cachePeerEntry.cachePeerName.141.142.121.5:cache2.hp.com

squid.cacheMesh.cachePeerTable.cachePeerEntry.cachePeerAddr.141.142.121.5:141.142.121.5

squid.cacheMesh.cachePeerTable.cachePeerEntry.cachePeerPortHttp.141.142.121.5:3128

squid.cacheMesh.cachePeerTable.cachePeerEntry.cachePeerPorticp.141.142.121.5:3130

squid.cacheMesh.cachePeerTable.cachePeerEntry.cachePeerType.141.142.121.5:1

squid.cacheMesh.cachePeerTable.cachePeerEntry.cachePeerState.141.142.121.5:1

squid.cacheMesh.cachePeerTable.cachePeerEntry.cachePeerPingsSent.141.142.121.5:3110

squid.cacheMesh.cachePeerTable.cachePeerEntry.cachePeerPingsAcked.141.142.121.5:3109

squid.cacheMesh.cachePeerTable.cachePeerEntry.cachePeerFetches.141.142.121.5:63

squid.cacheMesh.cachePeerTable.cachePeerEntry.cachePeerRtt.141.142.121.5:27

squid.cacheMesh.cachePeerTable.cachePeerEntry.cachePeerIgnored.141.142.121.5:398

squid.cacheMesh.cachePeerTable.cachePeerEntry.cachePeerKeepAlSent.141.142.121.5:63

squid.cacheMesh.cachePeerTable.cachePeerEntry.cachePeerKeepAlRecv.141.142.121.5:62

Note that in this example ICP table, there is only one peer in the table, cache2.hp.com.

In a next step 408, a neighbor cache is selected from the neighbor list. In a next step 410, the name or identification of the selected neighbor cache is cross-checked against the cache list. If the selected neighbor cache is not in the cache list, then control proceeds to step 412 where the cache list and the map display are updated to include the selected neighbor cache, so that the communication path between the selected cache and the selected neighbor cache neighboring the selected cache is reflected in the map display.

From step 412, control proceeds to step 414. If in step 410 the selected neighbor cache is in the cache list, then control proceeds to step 414. In step 414, the relationship between the selected neighbor cache and the cache selected from the cache list is added to the map display. The relationship can be indicated, for example, by the type associated with the selected neighbor cache in the neighbor list, and/or by other information provided in the neighbor list or in the ICP table. The relationship can indicate details about communications or a communication path between the selected neighbor cache and the cache selected from the cache list. For example, the type can indicate whether the relationship between the selected neighbor cache and the cache selected from the cache list is sibling-sibling, parent-child, or multicast.

The map display can show the cache elements in a logical order or arrangement with communication paths between them. The map display can also display or represent the cache elements in an order or arrangement that shows their geographical locations, along with logical or geographical routes of the communication paths between them. The map can represent the exact geographical locations, or the relative geographic or physical locations of the cache elements and/or communication paths between them. In addition, in either of the steps 412, 414 the map can be updated to show which customers are mapped to which caches in the network. Information about which customers are mapped to which caches can be included for example in the ICP tables obtained through repetition of the step 406.

The relationship between the selected neighbor cache and the cache selected from the cache list can also be stored in a manner or location that is easily accessible by the agent gathering the data for the map display. The agent (and the storage location) can be implemented in software on hardware resources of the network or on dedicated and/or independent hardware resources, or in any other appropriate fashion.

From step 414, control proceeds to step 416 where it is determined whether any neighbor caches remain in the neighbor list, that have not been evaluated and added to the map display. If yes, then control returns to step 408. If no, then control proceeds to step 418 where it is determined whether any caches remain in the cache list. If yes, then control returns to step 404. If no, then control proceeds to step 420, where the process ends.

With respect to the ICP table mentioned above in connection with step 406 of FIG. 4, the following paragraphs present additional information regarding an exemplary ICP table from a NLANR/SQUID MIB (National Laboratory for Applied Network Research/SQUID Management Information Base).

Note, the “SQUID” referred to above is an open source cache. Specifically, SQUID is a high-performance proxy caching server for web clients, supporting FTP (File Transfer Protocol), Gopher, and HTTP (Hyper Text Transfer Protocol) data objects. Unlike traditional caching software, SQUID handles all requests in a single, non-blocking, I/O-driven process. SQUID keeps meta data and especially hot objects cached in RAM, caches DNS lookups, supports non-blocking DNS lookups, and implements negative caching of failed requests. SQUID supports SSL, extensive access controls, and full request logging. By using the lightweight Internet Cache Protocol, SQUID caches can be arranged in a hierarchy or mesh for additional bandwidth savings. SQUID consists of a main server program SQUID, a Domain Name System lookup program DNS server, some optional programs for rewriting requests and performing authentication, and some management and client tools. When SQUID starts up, it spawns a configurable number of DNS server processes, each of which can perform a single, blocking Domain Name System (DNS) lookup. This reduces the amount of time the cache waits for DNS lookups. SQUID is derived from the ARPA-funded (Advanced Research Projects Agency—funded) Harvest project. Thus, the SQUID MIB is the SNMP MIB on a SQUID cache.

The hostname of the neighbor cache with IP address 141.142.121.5:

enterprises.nlanr.squid.cacheMesh.cachePeerTable.cachePeerEntry.cachePeerName.141.142.121.5=uc.us.ircache.net.

The IP address of the same neighbor cache:

enterprises.nlanr.squid.cacheMesh.cachePeerTable.cachePeerEntry.cachePeerAddr.141.142.121.5=IpAddress: 141.142.121.5.

The HTTP port of the same neighbor cache:

enterprises.nlanr.squid.cacheMesh.cachePeerTable.cachePeerEntry.cachePeerPortHttp.141.142.121.5=3128.

The ICP port of the same neighbor cache:

enterprises.nlanr.squid.cacheMesh.cachePeerTable.cachePeerEntry.cachePeerPortlcp.141.142.121.5=3130.

The type of the same neighbor cache, where Sibling=1, Parent==2, Multicast==3:

enterprises. nlanr.squid.cacheMesh.cachePeerTable.cachePeerEntry.cachePeerType.141.142.121.5=1.

The Up/Down state of the neighbor cache, wherein Up==1, Down==0:

enterprises.nlanr.squid.cacheMesh.cachePeerTable.cachePeerEntry.cachePeerState.141.142.121.5=1.

The number of ICP/HTCP queries sent to the neighbor cache:

enterprises.nlanr.squid.cacheMesh.cachePeerTable.cachePeerEntry.cachePeerPingsSent.141.142.121.5=Wrong Type (should be Counter32): 3110.

The number of ICP/HTCP replies received from the neighbor cache:

enterprises.nlanr.squid.cacheMesh.cachePeerTable.cachePeerEntry.cachePeerPingsAcked.141.142.121.5=Wrong Type (should be Counter32): 3109.

The number of HTTP requests forwarded to this neighbor:

enterprises.nlanr.squid.cacheMesh.cachePeerTable.cachePeerEntry.cachePeerFetches.141.142.121.5=Counter32: 63.

The Mean Round-Trip Time (RTT) for ICP/HTCP queries to this neighbor:

enterprises.nlanr.squid.cacheMesh.cachePeerTable.cachePeerEntry.cachePeerRtt.141.142.121.5=27.

The number of ICP/HTCP replies ignored from this neighbor. Replies are ignored if they are too late, or contain an error:

enterprises.nlanr.squid.cacheMesh.cachePeerTable.cachePeerEntry.cachePeerIgnored.141.142.121.5=Counter32: 398.

Number of HTTP requests sent to this neighbor with the Connection: keep-alive header:

enterprises.nlanr.squid.cacheMesh.cachePeerTable.cachePeerEntry.cachePeerKeepAlSent.141.142.121.5=Counter32: 63.

Number of HTTP responses received from this neighbor with the Connection: keep-alive header:

enterprises.nlanr.squid.cacheMesh.cachePeerTable.cachePeerEntry.cachePeerKeepAlRecv.141.142.121.5=Counter32: 62.

The IP address of a cache client:

enterprises.nlanr.squid.cacheMesh.cacheClientTable.cacheClientEntry.cacheClientAddr.212.24.128.4=IpAddress: 212.24.128.4.

In accordance with exemplary embodiments, caches in the CDN include internal algorithms for processing requests for cached information. In accordance with exemplary embodiments, the caches in the CDN include a common mechanism such as SNMP, that can be used to access each cache to determine the configuration, performance, and health information for that cache, including neighbor information and so forth. In accordance with exemplary embodiments, all the caches in the CDN support the NLANR/SQUID MIB. In accordance with exemplary embodiments, the agents that interact with the caches to gather information for the map display are capable of and equipped to use a variety of mechanisms, including for example SNMP and other mechanisms or protocols, for use in communicating with different caches to obtain configuration information, performance information, health information, neighbor information and so forth for the caches. Thus, in accordance with exemplary embodiments, the agents can access the caches even when there is no single common mechanism for interacting or communicating with all the caches.

It will be appreciated by those skilled in the art that exemplary embodiments can be embodied in other specific forms without departing from the spirit or essential characteristics thereof, and that the invention is not limited to the specific embodiments described herein.

For example, although exemplary embodiments are described in the context of a CDN operating on layers 4-7 of an IP protocol stack, exemplary embodiments can be implemented in systems using different protocols. For example, exemplary embodiments can be implemented at protocol levels where packet labeling information or information in the packet header or at the packet header level, indicates content delivery network source(s) and destination(s) for the content information in the packet. For example the network sources and destinations can be content managers and caches or their equivalent in a content delivery network that is an overlay on an existing network in accordance with a protocol.

Persons skilled in the art will appreciate that a machine readable medium can include software for causing a computing device to perform the exemplary method(s) and processes described herein.

The presently disclosed embodiments are therefore considered in all respects to be illustrative and not restrictive. The scope is indicated by the appended claims rather than the foregoing description, and all changes that come within the meaning and range and equivalents thereof are intended to be embraced therein.

1. A method for monitoring relationships between content devices in a content delivery network, the content devices including a management computer and a plurality of caches, the method comprising:
querying one of the content devices;
receiving a response from the queried content device indicating a content distribution path among the content devices; and
based on the received response, displaying a map showing the indicated content distribution path(s) among the content devices.

2. The method of claim 1, comprising:
mapping customers of the network to ones of the plurality of caches.

3. The method of claim 1, comprising:
organizing information on the map according to physical locations of the management computer and the plurality of caches.

4. The method of claim 3, wherein the content devices include a content manager, the method comprising:
organizing the information on the map according to relative physical locations of the content manager and the plurality of caches.

5. The method of claim 1, wherein the content devices include a content manager, and wherein the queried device is the content manager.

6. The method of claim 1, wherein:
the queried content device is a first cache;
the response indicates other caches in the network that the first cache will contact to request content in the event the first cache receives a request for content not in the first cache; and
the map shows which other caches in the network that the first cache will contact to request content in the event the first cache receives a request for content not in the first cache.

7. The method of claim 6, comprising:
mapping customers of the network to caches in the network.

8. The method of claim 7, comprising:
organizing information on the map according to physical locations of the caches in the network.

9. The method of claim 7, comprising:
organizing information on the map according to relative physical locations of the caches.

10. A system for monitoring relationships between content devices in a content delivery network, the content devices including a management computer and a plurality of caches, the system comprising:
an agent configured to query one of the content devices and receive a response from the queried content device indicating a content distribution path among the content devices; and
a display arranged to display a map showing the indicated content distribution path among the content devices.

11. A system for monitoring relationships between content devices in a content delivery network, the content devices including a management computer and a plurality of caches, the system comprising:
means for querying one of the content devices;
means for receiving a response from the queried content device indicating a content distribution path among the content devices; and
means for displaying a map showing the indicated content distribution path(s) among the content devices, based on the received response.

12. The system of claim 11, comprising:
means for organizing information on the map according to physical locations of the management computer and the plurality of caches.

13. The system of claim 12, comprising:
means for mapping customers of the network to caches in the network.

14. A machine readable medium comprising a computer program for causing a computer to:
query a content device in a content delivery network;
receive a response from the queried content device indicating a content distribution path among content devices in the content delivery network; and
based on the received response, display a map showing the indicated content distribution path(s) among the content devices.

15. The machine readable medium of claim 14, wherein the content devices include a management computer and a plurality of caches, and wherein the computer program causes the computer to map customers of the network to ones of the plurality of caches.

16. The machine readable medium of claim 14, wherein the content devices include a management computer and a plurality of caches, and wherein the computer program causes the computer to organize information on the map according to physical locations of the management computer and the plurality of caches.

17. The machine readable medium of claim 16, wherein the content devices include a content manager and a plurality of caches, and wherein the computer program causes the computer to organize information on the map according to relative physical locations of the content manager and the plurality of caches.
